(19) United States
(12) Patent Application Publication
(10) Pub. No.: US 2026/0178887 A1
(43) Pub. Date: Jun. 25, 2026

(54) MULTI-MODAL LARGE LANGUAGE MODELS COUPLED WITH PROBABILITY ENGINES

(71) Applicant: Capital One Services, LLC, McLean, VA (US)

(72) Inventors: Ayaz MEHMANI, Teaneck, NJ (US); Ruoyu SHAO, Allen, TX (US); Yiming LIU, McKinney, TX (US); Nilou ABBAS, Keller, TX (US)

(21) Appl. No.: 18/999,050

(22) Filed: Dec. 23, 2024

(51) Int. Cl. G06N 3/047

(52) U.S. Cl. CPC G06N 3/047

(57) ABSTRACT

In some implementations, a machine learning (ML) host may receive, from a client device, a request indicating an institution. The ML host may provide an indication of the institution to a foundational model, included in the suite of large language models, to receive a summary associated with the institution. The ML host may output the summary to the client device. The ML host may receive, from the client device, an audio stream associated with the institution and may generate a transcript of the audio stream. The ML host may provide the transcript to a rapid response model, included in the suite of large language models, to receive a conversation suggestion. The rapid response model may communicate with the probability engine to generate the conversation suggestion, and the conversation suggestion may increase a probability output by the probability engine. The ML host may output the conversation suggestion to the client device.

### BACKGROUND

Large language models (LLMs) are growing in popularity. LLMs use tokenization to accept natural language inputs and produce natural language outputs. However, LLMs are computationally intensive to train and to execute.

### SUMMARY

Some aspects described herein relate to a system for using a suite of large language models with a probability engine. The system may include one or more memories and one or more processors coupled to the one or more memories. The one or more processors may be configured to receive, from a client device, a request indicating an institution. The one or more processors may be configured to provide an indication of the institution to a foundational model, included in the suite of large language models, to receive a summary associated with the institution. The one or more processors may be configured to output the summary to the client device. The one or more processors may be configured to receive, from the client device, an audio stream associated with the institution. The one or more processors may be configured to generate a transcript of the audio stream. The one or more processors may be configured to provide the transcript to a rapid response model, included in the suite of large language models, to receive a conversation suggestion, wherein the rapid response model communicates with the probability engine to generate the conversation suggestion, and wherein the conversation suggestion increases a probability output by the probability engine. The one or more processors may be configured to output the conversation suggestion to the client device.

Some aspects described herein relate to a method of using a large language model with a probability engine. The method may include receiving, at a machine learning host and from a client device, a request indicating an institution. The method may include providing an indication of the institution to the large language model to receive a summary associated with the institution. The method may include transmitting, from the machine learning host and to the client device, the summary to the client device. The method may include receiving, at the machine learning host, an audio stream associated with the institution. The method may include generating, by the machine learning host, a transcript of the audio stream. The method may include providing the transcript to the large language model to receive a conversation suggestion, wherein the large language model communicates with the probability engine to generate the conversation suggestion, and wherein the conversation suggestion increases a probability output by the probability engine. The method may include transmitting, from the machine learning host and to the client device, the conversation suggestion to the client device.

Some aspects described herein relate to a non-transitory computer-readable medium that stores a set of instructions for using a suite of large language models with a probability engine by a device. The set of instructions, when executed by one or more processors of the device, may cause the device to transmit, to a machine learning host, a request indicating an institution. The set of instructions, when executed by one or more processors of the device, may cause the device to receive, in response to the request, a summary associated with the institution and from a foundational model included in the suite of large language models. The set of instructions, when executed by one or more processors of the device, may cause the device to transmit, to the machine learning host, an authorization to access an audio stream associated with the institution. The set of instructions, when executed by one or more processors of the device, may cause the device to receive, in response to the authorization, a conversation suggestion from a rapid response model included in the suite of large language models.

### BRIEF DESCRIPTION OF THE DRAWINGS

FIGS. 1A-1D are diagrams of an example implementation relating to using multi-modal LLMs coupled with probability engines, in accordance with some embodiments of the present disclosure.

FIGS. 2A-2B are diagrams of an example implementation relating to applying an LLM, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to using multi-modal LLMs coupled with probability engines, in accordance with some embodiments of the present disclosure.

FIG. 6 is a flowchart of an example process relating to providing input for multi-modal LLMs coupled with probability engines, in accordance with some embodiments of the present disclosure.

### DETAILED DESCRIPTION

The following detailed description of example implementations refers to the accompanying drawings. The same reference numbers in different drawings may identify the same or similar elements.

LLMs use tokenization to accept natural language inputs and produce natural language outputs. For example, LLMs may use a generative pre-trained transformer (GPT) neural network, which uses a transformer deep learning architecture that is pre-trained on large data sets of unlabeled text. However, general-purpose LLMs are computationally intensive to train and to execute. Therefore, refinement to improve accuracy is costlier as compared with smaller and more efficient neural network architectures.

Deploying an LLM during a real-time conversation, such as a phone conversation, or during a near-real-time conversation, such as an instant messaging conversation, may help guide a participant in the conversation. For example, the LLM may help the participant negotiate with another participant during a course of the conversation. However, the LLM may be computationally expensive to run during the conversation.

Some implementations described herein enable a foundational LLM to cooperate with a rapid response LLM. As a result, the foundational LLM may provide more detailed responses in advance of a conversation, and the rapid response LLM may provide faster responses during the conversation, which conserves computing resources as compared with trying to execute the foundational LLM during the conversation. Additionally, or alternatively, some implementations described herein enable the rapid response LLM to cooperate with a probability engine. For example, the rapid response LLM may select from different outputs based on increasing a probability predicted by the probability engine. Because the probability engine is more lightweight than neuron-heavy models like the rapid response LLM, the rapid response LLM may increase accuracy without significantly increasing computational cost.

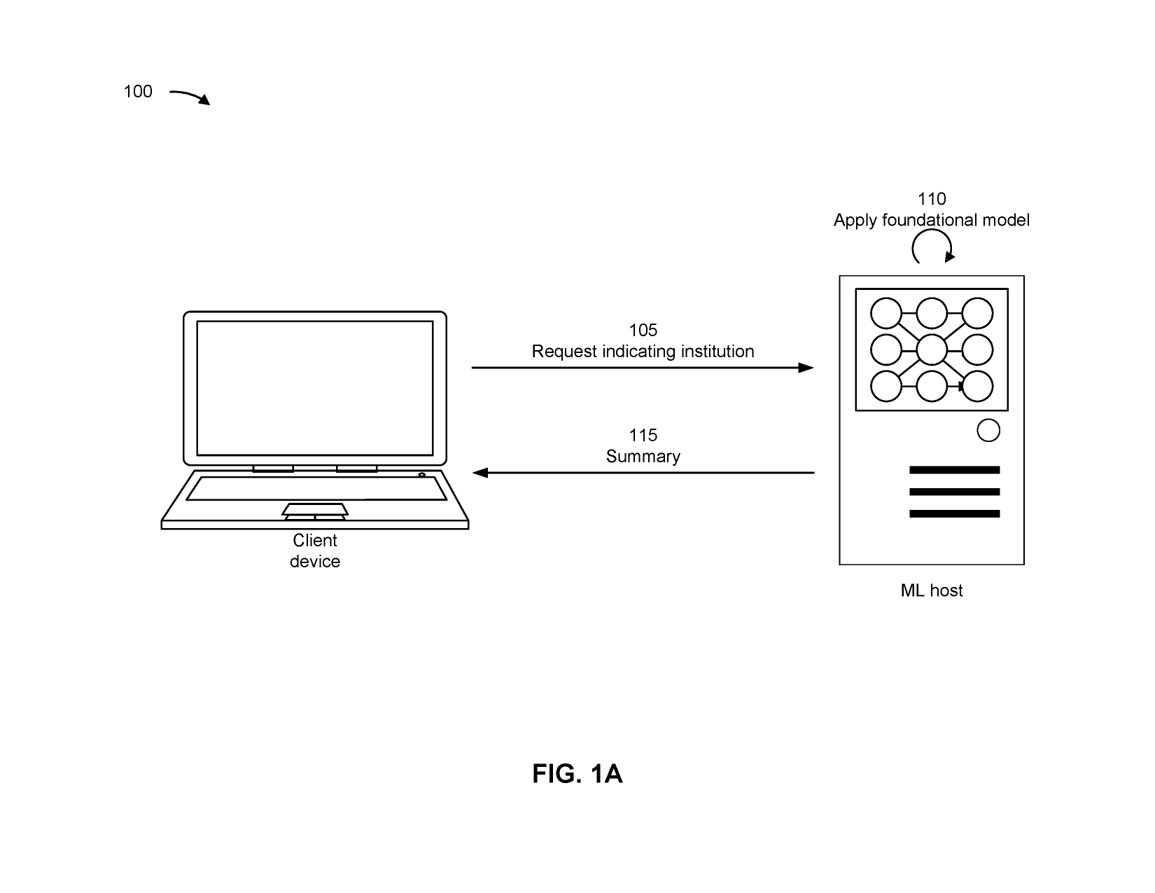

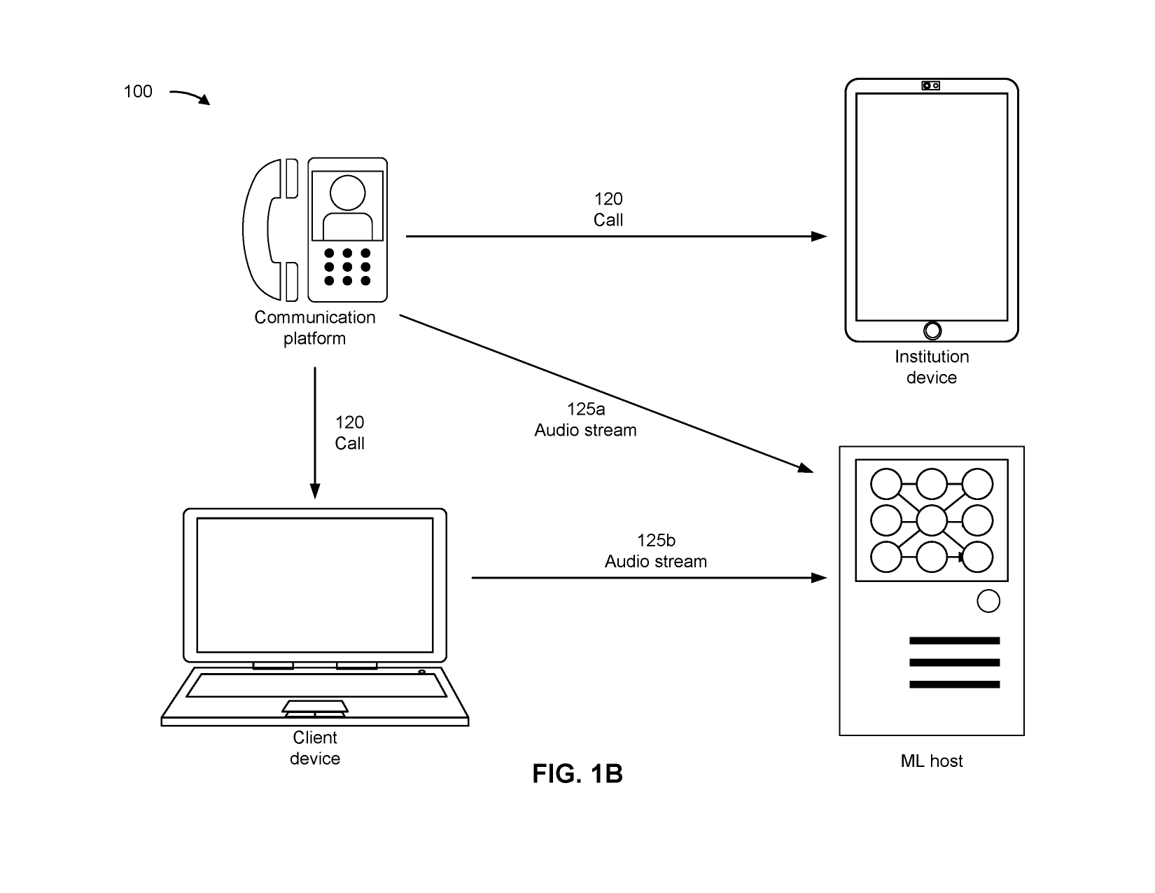

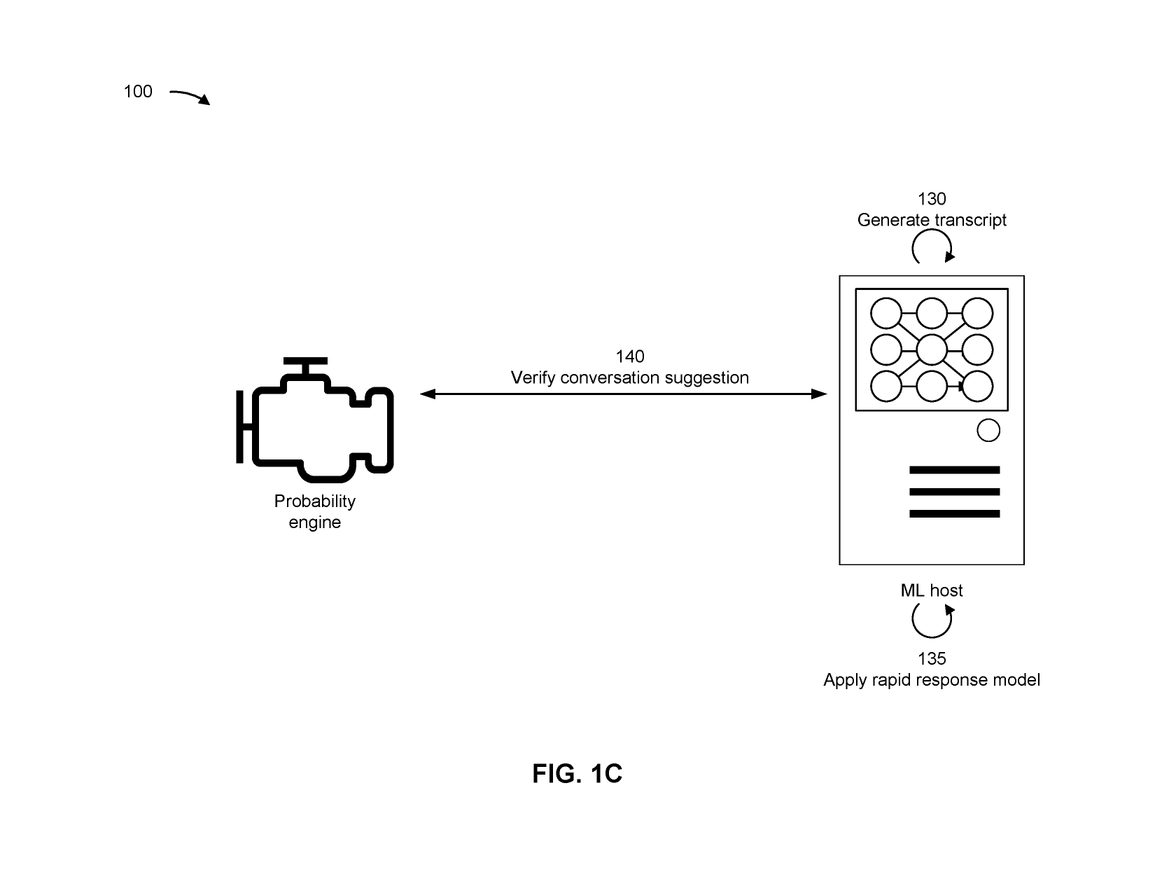

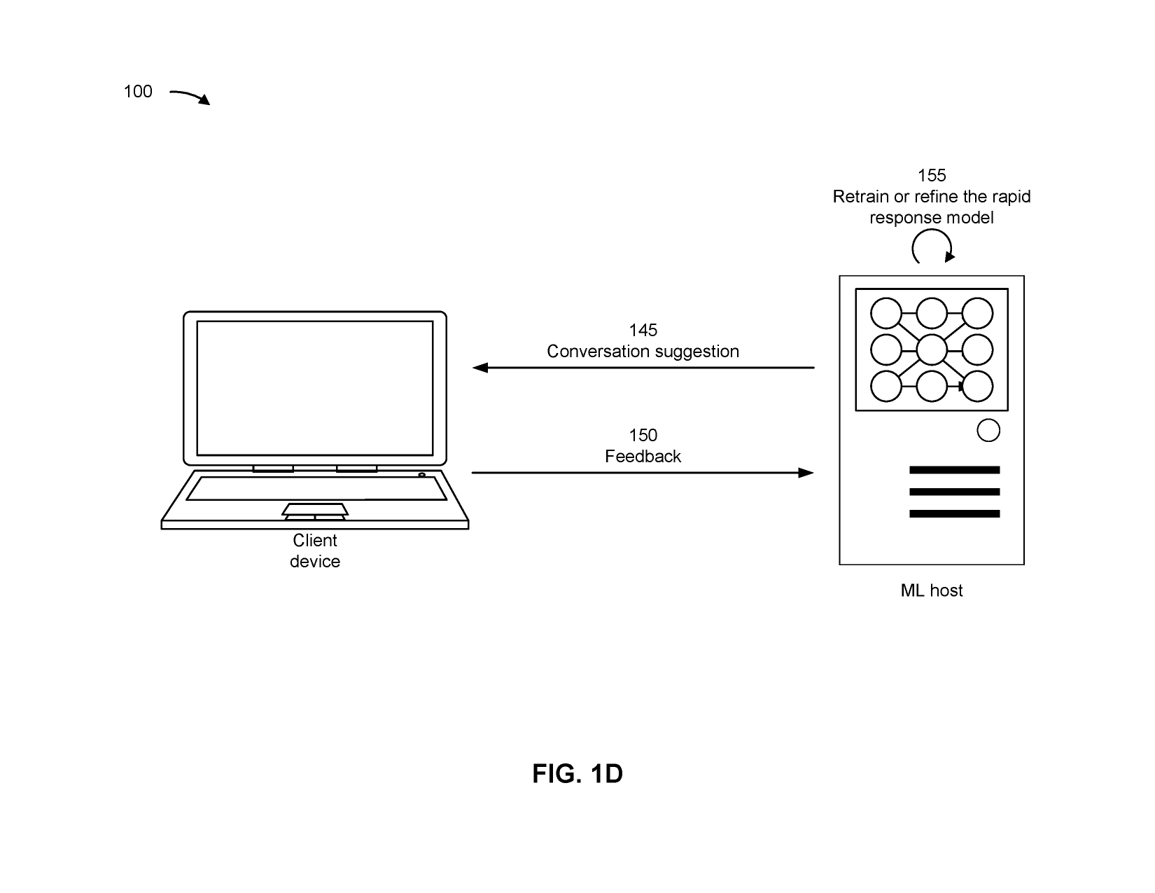

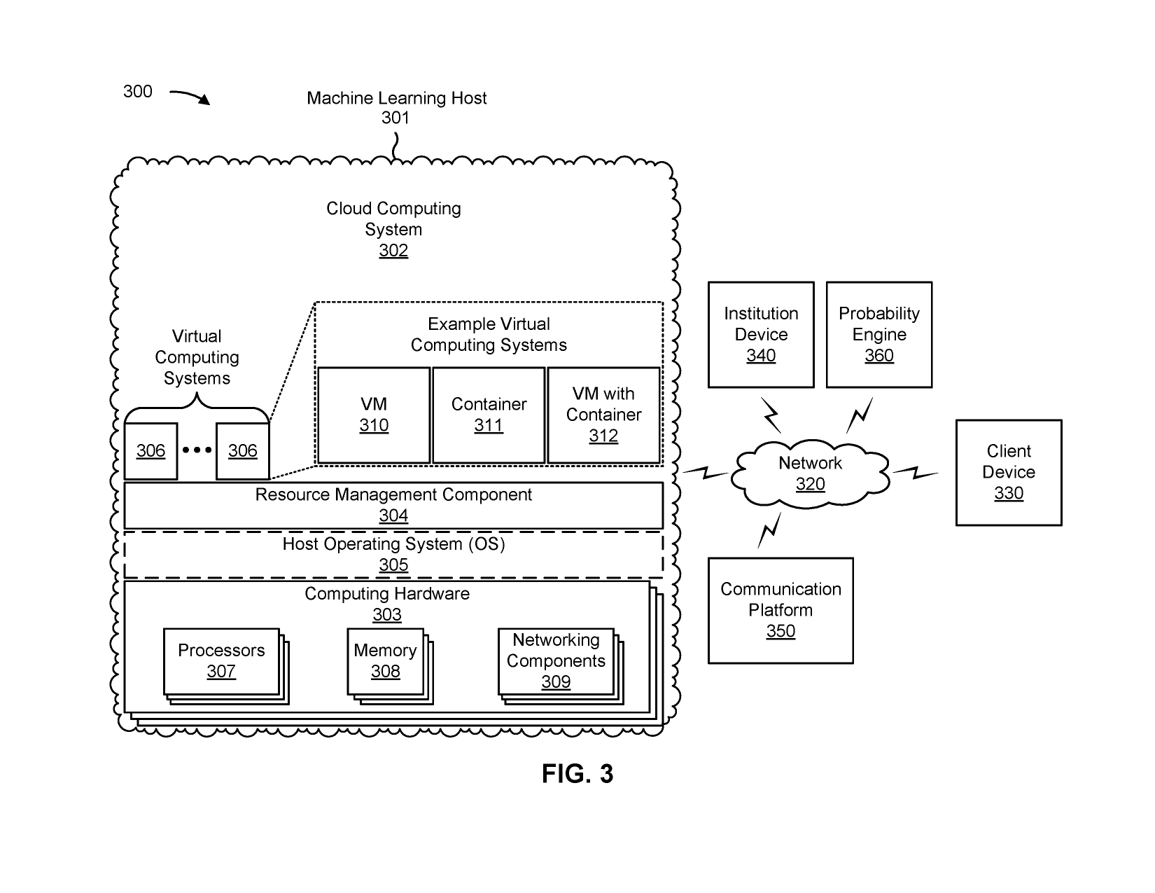

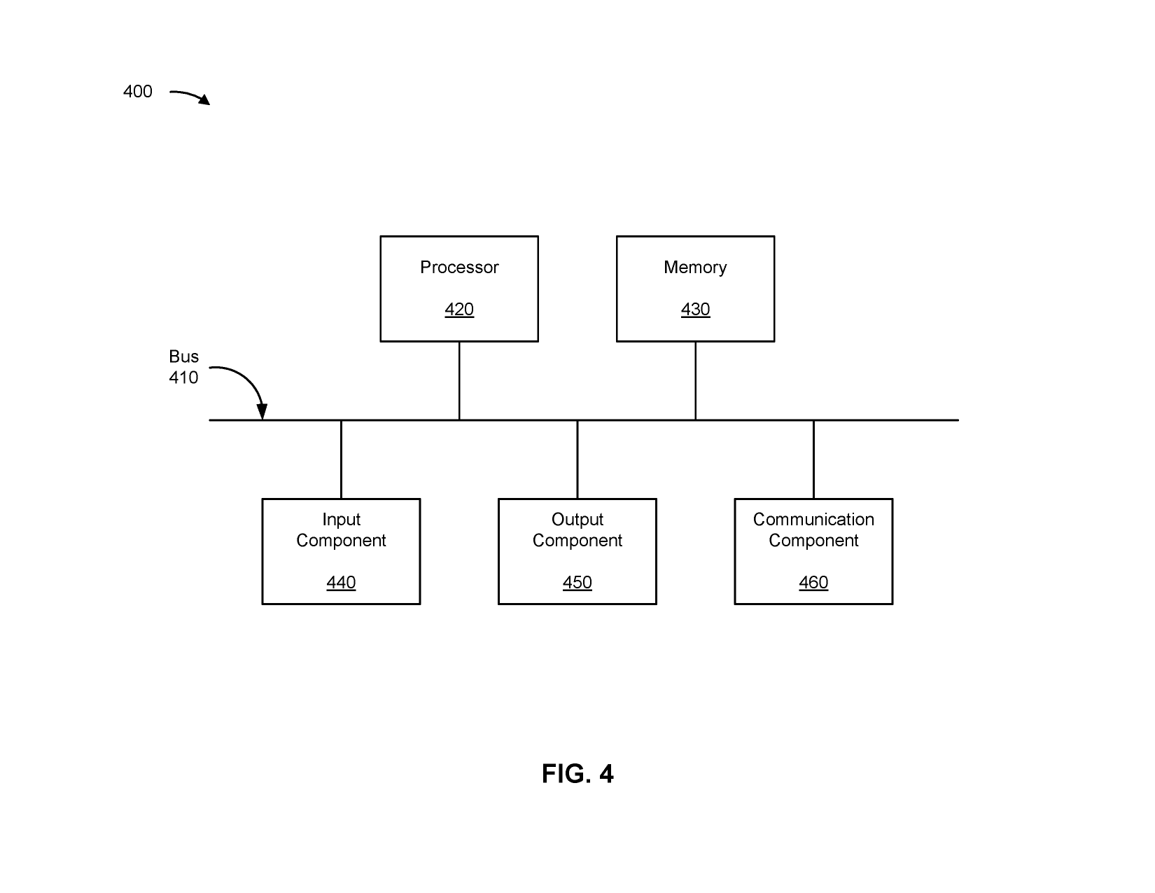

FIGS. 1A-1D are diagrams of an example 100 associated with using multi-modal LLMs coupled with probability engines. As shown in FIGS. 1A-1D, example 100 includes a client device, a machine learning (ML) host, a communication platform, an institution device, and a probability engine. These devices are described in more detail in connection with FIGS. 3 and 4.

As shown in FIG. 1A and by reference number 105, the client device may transmit, and the ML host may receive, a request indicating an institution. The request may be a hypertext transfer protocol (HTTP) request, a file transfer protocol (FTP) request, and/or an application programming interface (API) call, among other examples. The request may include (e.g., in a header and/or as an argument) a name, an index, or another type of alphanumeric identifier associated with the institution. The institution may include an automobile dealership or another type of entity with which a user of the client device expects to negotiate.

In one example, the user of the client device may provide input (e.g., via an input component of the client device) that triggers the client device to transmit the request. In some implementations, the user may interact with a user interface (UI) to provide the input. For example, a web browser (or another type of application) executed by the client device may navigate to a website controlled by (or at least associated with) the ML host. Accordingly, the client device may output a UI (e.g., via an output component of the client device) representing the website, and the user may interact with the UI to provide the input. Alternatively, the user may provide text input (e.g., via a command line or a shell, among other examples) to trigger the client device to transmit the request.

In some implementations, the client device may include a set of credentials with the request. The set of credentials may include a username and password, a passkey, a certificate, a signature, a private key, and/or biometric information, among other examples. Therefore, the ML host may validate the set of credentials (e.g., before processing the request). In some implementations, the client device may transmit the set of credentials separately from the request. For example, the client device may transmit the set of credentials initially, and the ML host may accept the request from the client device in response to validating the set of credentials. In another example, the ML host may prompt the client device in response to the request, and the client device may transmit the set of credentials in response to the prompt. Accordingly, the ML host may validate the set of credentials and may process the request in response to validating the set of credentials.

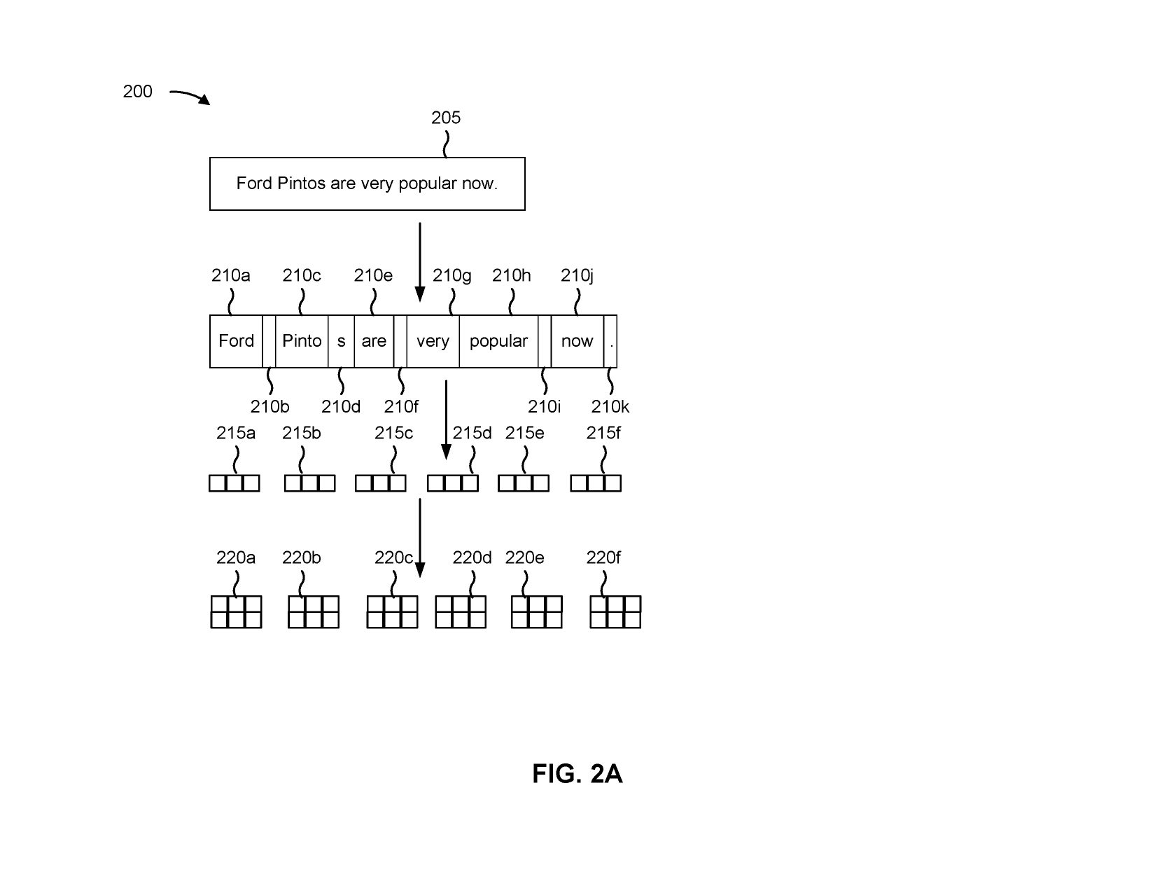

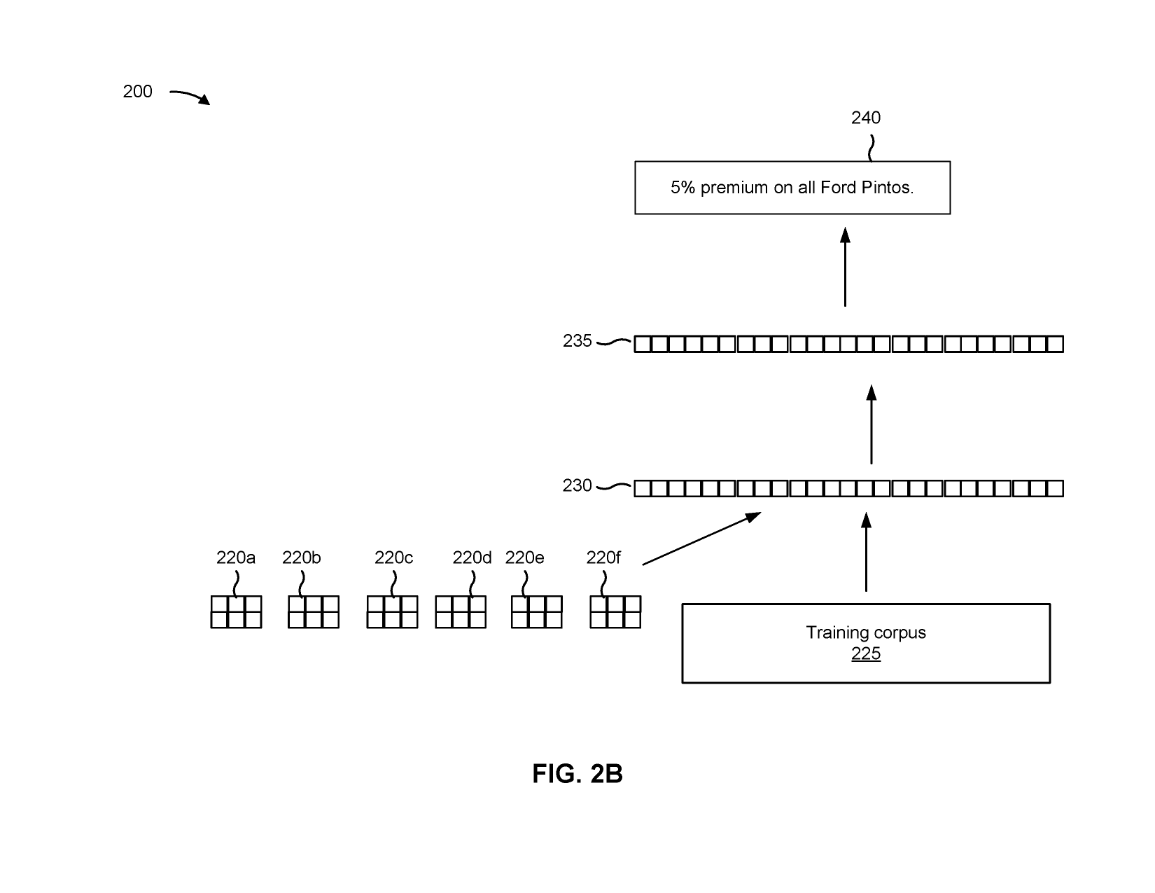

As shown by reference number 110, the ML host may apply a foundational model for the institution. For example, the ML host may provide an indication of the institution to the foundational model in order to receive a summary associated with the institution. The foundational model may be included in a suite of LLMs. For example, the suite of LLMs may include a rapid response model as well as the foundational model. The foundational model may process input and provide output as described in connection with FIGS. 2A-2B.

In some implementations, the foundational model is associated with a first tokenization scheme. For example, the foundational model may be trained using a tokenization scheme related to relative costs (e.g., using vocabulary specialized to relative costs). The foundational model may use a larger (or otherwise more computationally intensive) tokenization scheme as compared with the rapid response model.

In some implementations, the summary may be further based on a probability engine (e.g., a separate neural network, a random forest model, or another type of ML model). For example, the foundational model may communicate with the probability engine to generate the summary. The summary may therefore include one or more suggestions, associated with the institution, that the foundational model has determined will increase a probability calculated by the probability engine (e.g., increase the probability of negotiating a deal with the institution).

Although the example 100 is described in connection with the foundational model, other examples may include a single LLM rather than the suite of LLMs that includes the foundational model and the rapid response model. Accordingly, the ML host may use the single LLM to generate both the summary, as described above, and a conversation suggestion, as described below.

As shown by reference number 115, the ML host may output, and the client device may receive, the summary. The ML host may transmit, and the client device may receive, the summary in response to the request from the client device. The summary may be (or be included in) a file (e.g., a Microsoft^{®} Word document or a portable document format (pdf) file, among other examples).

In some implementations, the client device may transmit, and the ML host may receive, feedback associated with the summary. For example, the feedback may include a ranking (whether quantitative, such as a numerical score, and/or qualitative, such as a thumbs-up or thumbs-down or a letter grade) associated with the summary. Additionally, or alternatively, the feedback may include indications of locations in the summary (e.g., a page number, a line number, a set of pixels, or another type of location indicator) that are particularly good or particularly bad. Additionally, or alternatively, the feedback may include narrative feedback (e.g., unstructured text) about the summary. The feedback may be used to retrain (or at least refine) the foundational model. Because the foundational model may be retrained and/or refined less frequently than the rapid response model, the ML host may receive, store, and aggregate feedback from multiple client devices before retraining and/or refining the foundational model.

As shown in FIG. 1B and by reference number 120, the communication platform may facilitate a call between the client device and the institution device. For example, the user of the client device may initiate the call to a representative of the institution, and the representative may use the institution device to join the call. The call may be a voice call (whether using a telecommunication protocol or a voice over Internet protocol (VoIP), among other examples) or a video call (e.g., using Zoom^{®}, Microsoft Teams^{®}, or another type of video conferencing platform). The call may be (at least a part of) a negotiation between the institution (e.g., an automobile dealership) and the user of the client device (e.g., representing a financial entity or another party).

In some implementations, the client device may transmit, and the ML host may receive, an authorization to access an audio stream associated with the institution. The authorization may include a password, a certificate, a signature, a token, and/or another set of credentials that the ML host may use to access the audio stream. For example, the ML host may transmit, and the communication platform may receive, a request with the authorization. Accordingly, as shown by reference number 125a, the communication platform may transmit, and the ML host may receive, the audio stream (of the call between the client device and the institution device). The communication platform may transmit, and the ML host may receive, the audio stream in response to the request from the ML host.

As an alternative to the client device providing the authorization to the ML host, the client device may transmit, and the communication platform may receive, a command to forward the audio stream to the ML host. Accordingly, the communication platform may transmit, and the ML host may receive, the audio stream in response to the command from the client device.

Rather than receiving the audio stream from the communication platform, the ML host may receive the audio stream from the client device, as shown by reference number 125b. For example, the client device may transmit, and the ML host may receive, a copy of audio packets encoded by the client device (e.g., audio packets encoding a voice of the user of the client device and transmitted to the institution device via the communication platform). Additionally, the client device may transmit, and the ML host may receive, a copy of audio packets decoded by the client device (e.g., audio packets encoding a voice of the representative using the institution device and received by the client device via the communication platform).

As shown in FIG. 1C and by reference number 130, the ML host may generate a transcript of the audio stream. For example, the ML host may apply a speech-to-text algorithm (e.g., provided by a library used by the ML host) to generate the transcript. By generating the transcript automatically, the ML host may use LLMs (as described herein) to process the call; the LLMs otherwise could not process the audio stream of the call.

As shown by reference number 135, the ML host may apply the rapid response model for the call. For example, the ML host may provide the transcript to the rapid response model in order to receive a conversation suggestion. The rapid response model may be included in the suite of LLMs. For example, the suite of LLMs may include the foundational model as well as the rapid response model. The rapid response model may process input and provide output as described in connection with FIGS. 2A-2B.

In some implementations, the rapid response model is associated with a second tokenization scheme different than the first tokenization scheme (for the foundational model). For example, the foundational model may be trained using a tokenization scheme related to vehicle makes and models (e.g., using vocabulary specialized to vehicles). The rapid response model may use a smaller (or otherwise less computationally intensive) tokenization scheme as compared with the foundational model. By using a leaner model during the call, the ML host may conserve computational resources that otherwise would have been expended in executing the foundational model during the call. Accordingly, the ML host may apply the rapid response model multiple times during the call without consuming an inordinate amount of computational resources.

In some implementations, the conversation suggestion may be further based on the probability engine. For example, the rapid response model may communicate with the probability engine to generate the summary. The conversation suggestion may therefore be verified (e.g., by the ML host) in order to increase a probability calculated by the probability engine (e.g., increase the probability of negotiating a deal with the institution), as shown by reference number 140.

The rapid response model may be trained and/or refined more recently than the foundational model. For example, because the rapid response model is less computationally intensive, the rapid response model may be updated more often to improve accuracy without incurring larger costs, such as the costs associated with training and/or refining the foundational model.

Although the example 100 is described in connection with the rapid response model, other examples may include a single LLM rather than the suite of LLMs that includes the foundational model and the rapid response model. Accordingly, the ML host may use the single LLM to generate both the conversation suggestion and the summary, as described above.

Although the example 100 is described in connection with the call, other examples may include an instant messaging conversation between the client device and the institution device. The instant messaging conversation may be (at least a part of) a negotiation between the institution (e.g., an automobile dealership) and the user of the client device (e.g., representing a financial entity or another party). In such examples, the communication platform may be an instant messaging platform (e.g., using Microsoft Teams, Slack^{®}, or another type of instant messaging software). Additionally, the communication platform and/or the client device may transmit a copy of the instant messaging conversation to the ML host, and the ML host may use the instant messaging conversation directly (e.g., without generating a transcript using speech-to-text).

As shown in FIG. 1D and by reference number 145, the ML host may output, and the client device may receive, the conversation suggestion. The ML host may transmit, and the client device may receive, the conversation suggestion in response to the audio stream (and/or the authorization to access the audio stream). The conversation suggestion may be (or be included in) a push notification.

As shown by reference number 150, the client device may transmit, and the ML host may receive, feedback associated with the conversation suggestion. For example, the feedback may include a ranking (whether quantitative, such as a numerical score, and/or qualitative, such as a thumbs-up or thumbs-down or a letter grade) associated with the conversation suggestion. Additionally, or alternatively, the feedback may include indications of locations in the conversation suggestion (e.g., a page number, a line number, a set of pixels, or another type of location indicator) that are particularly good or particularly bad. Additionally, or alternatively, the feedback may include narrative feedback (e.g., unstructured text) about the conversation suggestion. The feedback may be used to retrain (or at least refine) the rapid response model, as shown by reference number 155. Additionally, or alternatively, the ML host may retrain and/or refine the rapid response model using the transcript. For example, after the call terminates, the ML host may determine an outcome of the call (e.g., whether a deal was negotiated) from the transcript. Accordingly, the ML host may retrain and/or refine the rapid response model using the outcome of the call.

By using techniques as described in connection with FIGS. 1A-1D, the ML host may use both the foundational model and the rapid response model. As a result, the foundational model may provide the summary in advance of the call, and the rapid response model may provide the conversation suggestion during the call, which conserves computing resources as compared with trying to execute the foundational model during the call. Additionally, the rapid response model (and optionally the foundational model) may cooperate with the probability engine. For example, the rapid response model may select the conversation suggestion based on increasing the probability predicted by the probability engine. Because the probability engine is more lightweight than neuron-heavy models like the rapid response model, the rapid response model may increase accuracy without significantly increasing computational cost.

As indicated above, FIGS. 1A-1D are provided as an example. Other examples may differ from what is described with regard to FIGS. 1A-1D.

FIGS. 2A-2B are diagrams of an example 200 associated with applying an LLM. The example 200 depicts a process performed by an ML host executing the LLM (e.g., in response to input from a client device). These devices are described in more detail in connection with FIGS. 3 and 4.

The LLM may include one or more encoding layers, each encoding layer with a self-attention layer and a feed-forward neural network. FIG. 2A depicts operations performed by an encoding layer.

An input 205 to the LLM may be a natural language sentence (e.g., from a transcript, as described in connection with FIG. 1C). The input may be transformed into a set of tokens 210 using a tokenization scheme. As shown in FIG. 2A, some tokens are for words (e.g., tokens 210a, 210e, 210g, 210h, and 210j), some tokens are for fractional words (e.g., tokens 210c and 210d), and some tokens are for punctuation (e.g., tokens 210b, 210f, 210i, and 210k). The set of tokens 210 are transformed into a set of vectors 215 using an embedding space. Some tokens may be discarded, such that the set of vectors 215 is smaller than the set of tokens (e.g., vectors 215a, 215b, 215c, 215d, 215e, and 215f are generated from the larger set of tokens). Accordingly, the tokenization scheme and the embedding space may be selected to increase accuracy (e.g., for a foundational model) or speed (e.g., for a rapid response model).

As shown in FIG. 2A, the set of vectors 215 may be transformed into a set of matrices 220. The set of matrices 220 may encode tokens as well as attention scores associated with the tokens. The attention scores mathematically represent relations between words in the input 205 (e.g., grammatical and logical relations).

The LLM may further include one or more decoding layers, each decoding layer with a self-attention layer, an attention layer, and a feed-forward neural network. FIG. 2B depicts operations performed by a decoding layer. The set of matrices 220 from the encoding layer(s) may be transformed into a score vector 230. A size of the score vector 230 may be determined by a size of a training corpus 225 for the LLM. Accordingly, the training corpus 225 may be selected to increase accuracy (e.g., by increasing output vocabulary) or speed (e.g., by limited output vocabulary and thus limiting the size of the score vector 230).

The score vector 230 may be transformed into a probability vector 235 (e.g., using a probability function and/or a normalization function). The probability vector 235 may indicate a subsequent word to include in output from the LLM. Accordingly, an output sentence 240 may be constructed one word at a time using the decoding layer(s).

As indicated above, FIGS. 2A-2B are provided as an example. Other examples may differ from what is described with regard to FIGS. 2A-2B.

FIG. 3 is a diagram of an example environment 300 in which systems and/or methods described herein may be implemented. As shown in FIG. 3, environment 300 may include a machine learning host 301, which may include one or more elements of and/or may execute within a cloud computing system 302. The cloud computing system 302 may include one or more elements 303-312, as described in more detail below. As further shown in FIG. 3, environment 300 may include a network 320, a client device 330, an institution device 340, a communication platform 350, and/or a probability engine 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the machine learning host 301 may include one or more elements 303-312 of the cloud computing system 302, may execute within the cloud computing system 302, and/or may be hosted within the cloud computing system 302, in some implementations, the machine learning host 301 may not be cloud-based (e.g., may be implemented outside of a cloud computing system) or may be partially cloud-based. For example, the machine learning host 301 may include one or more devices that are not part of the cloud computing system 302, such as device 400 of FIG. 4, which may include a standalone server or another type of computing device. The machine learning host 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The client device 330 may include one or more devices capable of receiving, generating, storing, processing, and/or providing information associated with institutions and audio streams, as described elsewhere herein. The client device 330 may include a communication device and/or a computing device. For example, the client device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The institution device 340 may include one or more devices capable of receiving, generating, storing, processing, and/or providing information associated with audio streams, as described elsewhere herein. The institution device 340 may include a communication device and/or a computing device. For example, the institution device 340 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The communication platform 350 may include one or more devices capable of receiving, generating, storing, processing, and/or providing information associated with messaging services (e.g., a Slack server or another similar type of device), telecommunications services (e.g., a cell tower or another similar type of device), and/or video conferencing services (e.g., a Microsoft server, a Google^{®} server, or another similar type of device). The communication platform 350 may include a communication device and/or a computing device. For example, the communication platform 350 may include a server, such as an application server, a client server, a web server, a database server, a host server, a proxy server, a virtual server (e.g., executing on computing hardware), or a server in a cloud computing system.

The probability engine 360 may include one or more devices capable of receiving, generating, storing, processing, providing, and/or routing information associated with a probability model, as described elsewhere herein. The probability engine 360 may include a communication device and/or a computing device. For example, the probability engine 360 may include a server, such as an application server, a client server, a web server, a database server, a host server, a proxy server, a virtual server (e.g., executing on computing hardware), or a server in a cloud computing system. In some implementations, the probability engine 360 may include computing hardware used in a cloud computing environment.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with multi-modal LLMs coupled with probability engines. The device 400 may correspond to a client device 330, an institution device 340, a communication platform 350, and/or a probability engine 360. In some implementations, a client device 330, an institution device 340, a communication platform 350, and/or a probability engine 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

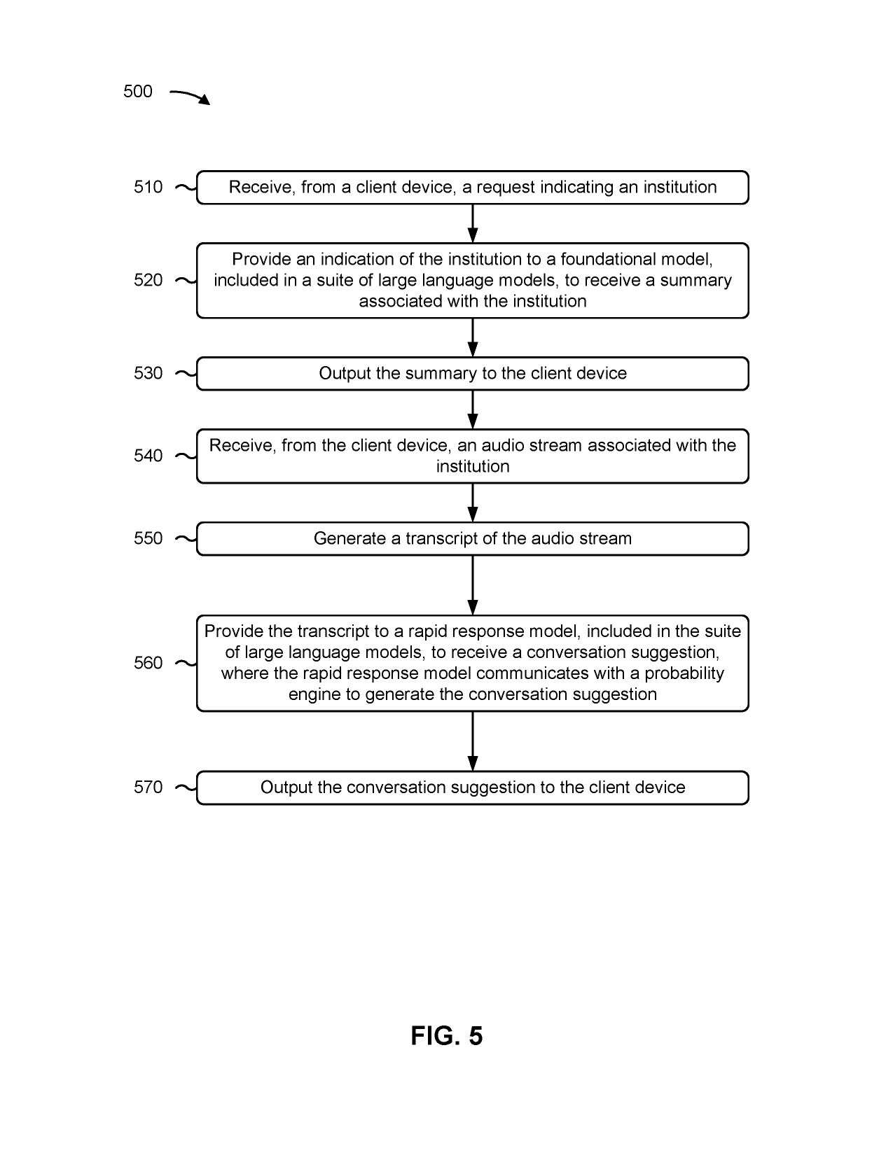

FIG. 5 is a flowchart of an example process 500 associated with using multi-modal LLMs coupled with probability engines. In some implementations, one or more process blocks of FIG. 5 may be performed by a machine learning host 301. In some implementations, one or more process blocks of FIG. 5 may be performed by another device or a group of devices separate from or including the machine learning host 301, such as a client device 330, an institution device 340, a communication platform 350, and/or a probability engine 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a client device, a request indicating an institution (block 510). For example, the machine learning host 301 (e.g., using processor 420, memory 430, input component 440, and/or communication component 460) may receive, from a client device, a request indicating an institution, as described above in connection with reference number 105 of FIG. 1A. As an example, the request may include (e.g., in a header and/or as an argument) a name, an index, or another type of alphanumeric identifier associated with the institution. The institution may include an automobile dealership or another type of entity with which a user of the client device expects to negotiate.

As further shown in FIG. 5, process 500 may include providing an indication of the institution to a foundational model, included in a suite of large language models, to receive a summary associated with the institution (block 520). For example, the machine learning host 301 (e.g., using processor 420, memory 430, and/or communication component 460) may provide an indication of the institution to a foundational model, included in a suite of large language models, to receive a summary associated with the institution, as described above in connection with reference number 110 of FIG. 1A. As an example, the foundational model may process input and provide output as described in connection with FIGS. 2A-2B.

As further shown in FIG. 5, process 500 may include outputting the summary to the client device (block 530). For example, the machine learning host 301 (e.g., using processor 420, memory 430, output component 450, and/or communication component 460) may output the summary to the client device, as described above in connection with reference number 115 of FIG. 1A. As an example, the machine learning host 301 may output a file including the summary.

As further shown in FIG. 5, process 500 may include receiving, from the client device, an audio stream associated with the institution (block 540). For example, the machine learning host 301 (e.g., using processor 420, memory 430, and/or communication component 460) may receive, from the client device, an audio stream associated with the institution, as described above in connection with FIG. 1B. As an example, the machine learning host 301 may receive a copy of audio packets encoded and decoded by the client device.

As further shown in FIG. 5, process 500 may include generating a transcript of the audio stream (block 550). For example, the machine learning host 301 (e.g., using processor 420, memory 430, and/or communication component 460) may generate a transcript of the audio stream, as described above in connection with reference number 130 of FIG. 1C. As an example, the machine learning host 301 may use a speech-to-text library to generate the transcript.

As further shown in FIG. 5, process 500 may include providing the transcript to a rapid response model, included in the suite of large language models, to receive a conversation suggestion, where the rapid response model communicates with a probability engine to generate the conversation suggestion (block 560). For example, the machine learning host 301 (e.g., using processor 420, memory 430, and/or communication component 460) may provide the transcript to a rapid response model, included in the suite of large language models, to receive a conversation suggestion, where the rapid response model communicates with a probability engine to generate the conversation suggestion, as described above in connection with FIG. 1C. As an example, the rapid response model may process input and provide output as described in connection with FIGS. 2A-2B. The machine learning host 301 may verify that the conversation suggestion increases a probability output by the probability engine.

As further shown in FIG. 5, process 500 may include outputting the conversation suggestion to the client device (block 570). For example, the machine learning host 301 (e.g., using processor 420, memory 430, output component 450, and/or communication component 460) may output the conversation suggestion to the client device, as described above in connection with reference number 145 of FIG. 1D. As an example, the machine learning host 301 may output a push notification including the conversation suggestion.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

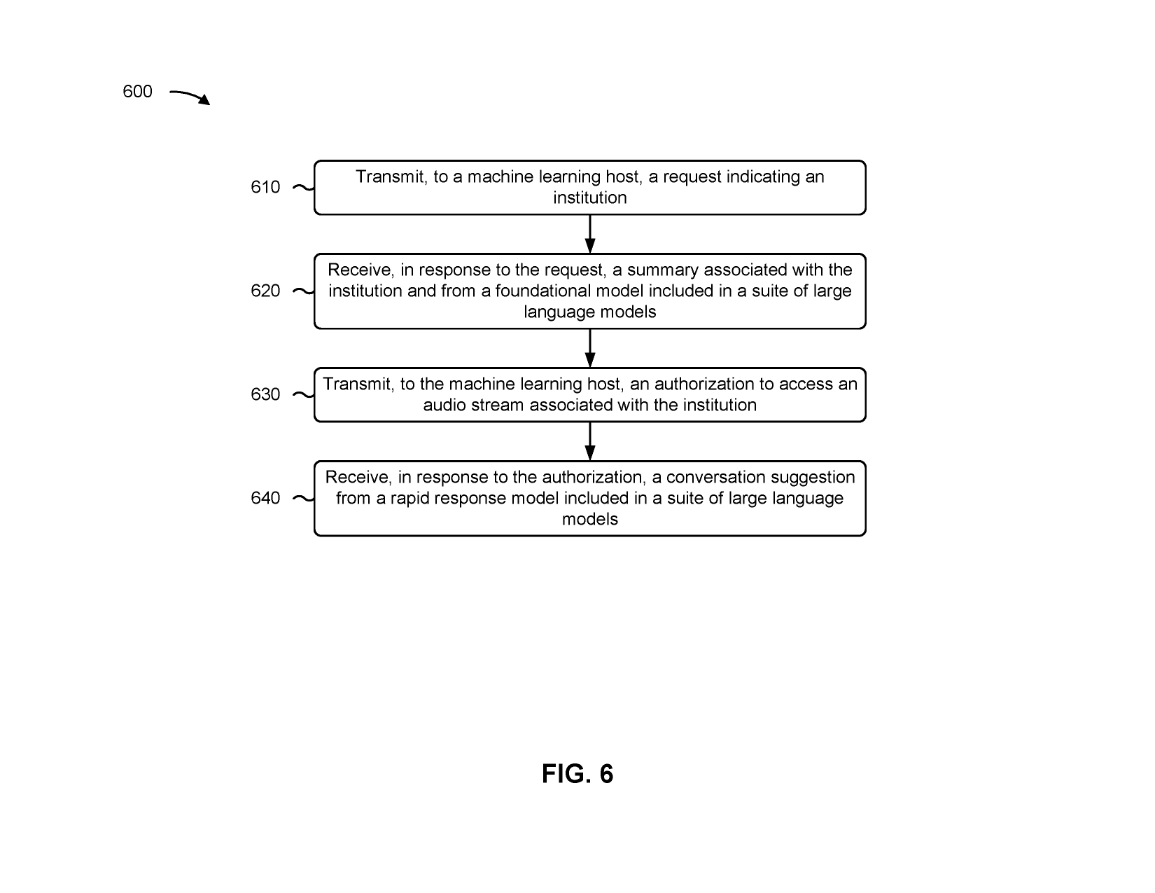

FIG. 6 is a flowchart of an example process 600 associated with providing input for multi-modal LLMs coupled with probability engines. In some implementations, one or more process blocks of FIG. 6 may be performed by a client device 330. In some implementations, one or more process blocks of FIG. 6 may be performed by another device or a group of devices separate from or including the client device 330, such as a machine learning host 301, an institution device 340, a communication platform 350, and/or a probability engine 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a machine learning host, a request indicating an institution (block 610). For example, the client device 330 (e.g., using processor 420, memory 430, and/or communication component 460) may transmit, to a machine learning host, a request indicating an institution, as described above in connection with reference number 105 of FIG. 1A. As an example, a user of the client device 330 may provide input (e.g., via input component 440) that triggers the client device 330 to transmit the request. The input from the user may indicate the institution.

As further shown in FIG. 6, process 600 may include receiving, in response to the request, a summary associated with the institution and from a foundational model included in the suite of large language models (block 620). For example, the client device 330 (e.g., using processor 420, memory 430, and/or communication component 460) may receive, in response to the request, a summary associated with the institution and from a foundational model included in the suite of large language models, as described above in connection with reference number 115 of FIG. 1A. As an example, the client device 330 may receive a file including the summary.

As further shown in FIG. 6, process 600 may include transmitting, to the machine learning host, an authorization to access an audio stream associated with the institution (block 630). For example, the client device 330 (e.g., using processor 420, memory 430, and/or communication component 460) may transmit, to the machine learning host, an authorization to access an audio stream associated with the institution, as described above in connection with FIG. 1B. As an example, the authorization may include a password, a certificate, a signature, a token, and/or another set of credentials that the machine learning host may use to access the audio stream.

As further shown in FIG. 6, process 600 may include receiving, in response to the authorization, a conversation suggestion from a rapid response model included in the suite of large language models (block 640). For example, the client device 330 (e.g., using processor 420, memory 430, and/or communication component 460) may receive, in response to the authorization, a conversation suggestion from a rapid response model included in the suite of large language models, as described above in connection with reference number 145 of FIG. 1D. As an example, the client device 330 may receive a push notification including the conversation suggestion.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using a suite of large language models with a probability engine, the system comprising:
one or more memories; and
one or more processors, communicatively coupled to the one or more memories, configured to:
receive, from a client device, a request indicating an institution;
provide an indication of the institution to a foundational model, included in the suite of large language models, to receive a summary associated with the institution;
output the summary to the client device;
receive, from the client device, an audio stream associated with the institution;
generate a transcript of the audio stream;
provide the transcript to a rapid response model, included in the suite of large language models, to receive a conversation suggestion, wherein the rapid response model communicates with the probability engine to generate the conversation suggestion, and wherein the conversation suggestion increases a probability output by the probability engine; and
output the conversation suggestion to the client device.

2. The system of claim 1, wherein the rapid response model was trained or refined more recently than the foundational model.

3. The system of claim 1, wherein the foundational model is associated with a first tokenization scheme, and the rapid response model is associated with a second tokenization scheme different than the first tokenization scheme.

4. The system of claim 1, wherein the foundational model communicates with the probability engine to generate the summary.

5. The system of claim 1, wherein the one or more processors, to receive the audio stream, are configured to:
receive a copy of audio packets encoded and decoded by the client device.

6. The system of claim 1, wherein the one or more processors are configured to:
retrain or refine the rapid response model using the transcript.

7. The system of claim 1, wherein the one or more processors are configured to:
receive, from the client device, feedback associated with the conversation suggestion; and
retrain or refine the rapid response model using the feedback.

8. A method of using a large language model with a probability engine, comprising:
receiving, at a machine learning host and from a client device, a request indicating an institution;
providing an indication of the institution to the large language model to receive a summary associated with the institution;
transmitting, from the machine learning host and to the client device, the summary to the client device;
receiving, at the machine learning host, an audio stream associated with the institution;
generating, by the machine learning host, a transcript of the audio stream;
providing the transcript to the large language model to receive a conversation suggestion, wherein the large language model communicates with the probability engine to generate the conversation suggestion, and wherein the conversation suggestion increases a probability output by the probability engine; and
transmitting, from the machine learning host and to the client device, the conversation suggestion to the client device.

9. The method of claim 8, wherein the large language model is trained using a tokenization scheme related to relative costs.

10. The method of claim 8, wherein the large language model is trained using a tokenization scheme related to vehicle makes and models.

11. The method of claim 8, further comprising:
receiving, from the client device, a set of credentials associated with a communication platform; and
transmitting, to the communication platform, a request with the set of credentials,
wherein the audio stream is received from the communication platform in response to the request.

12. The method of claim 8, wherein the summary comprises a file.

13. The method of claim 8, wherein the conversation suggestion comprises a push notification.

14. A non-transitory computer-readable medium storing a set of instructions for using a suite of large language models with a probability engine, the set of instructions comprising:
one or more instructions that, when executed by one or more processors of a device, cause the device to:
transmit, to a machine learning host, a request indicating an institution;
receive, in response to the request, a summary associated with the institution and from a foundational model included in the suite of large language models;
transmit, to the machine learning host, an authorization to access an audio stream associated with the institution; and
receive, in response to the authorization, a conversation suggestion from a rapid response model included in the suite of large language models.

15. The non-transitory computer-readable medium of claim 14, wherein the summary is further based on the probability engine.

16. The non-transitory computer-readable medium of claim 14, wherein the conversation suggestion is further based on the probability engine.

17. The non-transitory computer-readable medium of claim 14, wherein the one or more instructions, when executed by the one or more processors, cause the device to:
receive input from a user of the device,
wherein the request is transmitted in response to the input.

18. The non-transitory computer-readable medium of claim 14, wherein the one or more instructions, when executed by the one or more processors, cause the device to:
receive input from a user of the device,
wherein the authorization is transmitted in response to the input.

19. The non-transitory computer-readable medium of claim 14, wherein the one or more instructions, when executed by the one or more processors, cause the device to:
transmit, to the machine learning host, feedback associated with the conversation suggestion.

20. The non-transitory computer-readable medium of claim 14, wherein the one or more instructions, when executed by the one or more processors, cause the device to:
transmit, to the machine learning host, feedback associated with the summary.
